(19) United States
(12) Patent Application Publication
(10) Pub. No.: US 2018/0264310 A1
(43) Pub. Date: Sep. 20, 2018

(54) MULTI-FUNCTION HAND WEIGHT AND METHOD

(71) Applicants: Anthony Curole, Panama City, FL (US); Kristin Curole, Panama City, FL (US)

(72) Inventors: Anthony Curole, Panama City, FL (US); Kristin Curole, Panama City, FL (US)

(21) Appl. No.: 15/900,793

(22) Filed: Feb. 20, 2018

Related U.S. Application Data
(60) Provisional application No. 62/472,532, filed on Mar. 16, 2017.

(51) Int. Cl. A63B 21/072; A63B 21/075; B65D 25/28; F21L 4/08; F21V 23/04; F21V 21/088

(52) U.S. Cl. CPC A63B 21/0724; A63B 21/0728; A63B 21/075; B65D 25/28; F21L 4/08; F21Y 2115/10; F21V 21/0885; F21V 23/0407; A63B 2225/687; A63B 2207/02; F21V 23/0414

(57) ABSTRACT

A multi-function hand weight includes a handle having a grip axis, a first end and a second end opposite the first end along the center axis. The handle includes a first handle compartment inside the handle and proximate the first end. The hand further includes a second handle compartment inside the handle and proximate the second end. A first stowage compartment is located on the first end of the handle. A first weight affixes to the first stowage compartment and creates a seal to close the first stowage compartment. A second weight affixes to the second stowage compartment and creates a seal to close the second stowage compartment. The handle and compartments together as a whole have the profile of a dumbbell weight. The multi-function hand weight is useful for discreetly carrying pet supplies.

### CROSS-REFERENCE TO RELATED APPLICATION

The present application is related to and claims priority to U.S. Provisional Patent Application No. 62/472,532 filed Mar. 16, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of exercise devices of existing art and more specifically relates to jogging dumbbells.

### Related Art

Responsible pet owners may carry a plurality of pet supplies wherever they take their pets. These pet supplies will always vary depending on the duration and location of where an owner takes a pet. Commonly traveled with pet supplies include: medications, waste bags, sanitary wipes and food. Regardless of what provisions are required, pet supplies are cumbersome to manage and carry from location to location. Pets require planning and effort to keep comfortable.

A common activity an owner has with a pet is to take the pet on a walk or a jog. Dogs are animals that require frequent walks. An owner is expected to clean up after a pet excretes waste as a commonly understood etiquette. This requires an owner to carry a stash of empty bags on each walk, and carry the full bags to a proper receptacle for disposal. A pet owner may prefer to not be seen carrying a bag of dog excrement. An owner may choose to return home to dispose of the bag of pet waste instead of proceeding to enjoy the outdoors with the pet. A suitable method to discreetly and efficiently carry pet waste and supplies is needed.

U.S. Pat. No. 7,506,615 to Mary M. Sansone relates to an animal waste collection and disposal system. The described animal waste collection and disposal system includes a portable carrying housing with a plurality of separately sealable compartments, an integral ergonomic handle and integral apparatus to mount a leash. The collection and disposal system includes an animal waste collection tongs device having an integral protective shield, and also includes a waste disposal device having a biodegradable bag and a catalyst pouch integral to the bag.

### SUMMARY OF THE INVENTION

In view of the foregoing disadvantages inherent in the known jogging dumbbell art, the present disclosure provides a novel multi-function hand weight (or poop on the run system). The general purpose of the present disclosure, which will be described subsequently in greater detail, is to provide a multi-function hand weight.

A multi-function hand weight is disclosed herein. The multi-function hand weight includes a handle having a grip axis, a first end, and a second end opposite the first end along the grip axis, the handle including a first handle compartment inside the handle and proximate the first end, and a second handle compartment inside the handle and proximate the second end. The multi-function hand weight also includes a first stowage compartment affixed to the first end of the handle, a first weight affixed to the first stowage compartment, a second stowage compartment affixed to the second end of the handle, and a second weight affixed to the second stowage compartment.

According to another embodiment, a method of using a multi-function hand weight is also disclosed herein. The method includes the step of providing multi-function hand weight for containing pet supplies, the multi-function hand weight including a handle having a grip axis, a first end, and a second end opposite the first end along the grip axis, the handle including a first handle compartment inside the handle and proximate the first end, and a second handle compartment inside the handle and proximate the second end, a first stowage compartment affixed to the first end of the handle, and a second stowage compartment affixed to the second end of the handle. The method also includes the steps of affixing a first weight to the first stowage compartment, on an end opposite from the first end of the handle relative to the center axis, affixing a second weight to the second stowage compartment, on an end opposite from the second end of the handle relative to the center axis, gripping the handle, and exercising.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a multi-function hand weight, constructed and operative according to the teachings of the present disclosure.

FIG. 1 is perspective view of a multi-function hand weight during an ‘in-use’ condition, according to an embodiment of the disclosure.

FIG. 2 is an exploded perspective view of the multi-function hand weight of FIG. 1, according to an embodiment of the present disclosure.

FIG. 3 is an exploded partially cutaway side view of the multi-function hand weight of FIG. 1, according to an embodiment of the present disclosure.

FIG. 4A is a detail view of portions of the multi-function hand weight of FIG. 1, according to an embodiment of the present disclosure.

FIG. 4B is a detail view of portions of the multi-function hand weight of FIG. 1, according to an embodiment of the present disclosure.

FIG. 5 is a flow diagram illustrating a method of use of a multi-function hand weight, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to pet waste container and more particularly to a multi-function hand weight as used to improve the discreet carrying of pet supplies.

Generally, the multi-function hand weight is a multi-function hand weight that allows a user to carry pet supplies such as bags, food and sanitary wipes as well as provide a storage location for pet waste. The multi-function hand weight also serves as adjustable weight jogging dumbbell and lighting system.

The multi-function hand weight includes a handle having a grip axis, a first end and a second end opposite the first end along the grip axis. The handle circumscribes the grip axis for a first maximum radial distance. The handle includes a first handle compartment inside the handle and proximate the first end. The first handle compartment contains a spindle configured to receive and store pet waste bags. A first access panel is configured to provide access to the first handle compartment. The first access panel is pivotably connected to the first handle compartment and pivots between a latched state and an unlatched state, where the latched state creates a fluid-proof seal with the first handle compartment. The handle further includes a second handle compartment inside the handle and proximate the second end. A second access panel is configured to provide access to the second handle compartment. The second access panel is pivotably connected to the second handle compartment and pivots between a latched state and an unlatched state, where the latched state creates a fluid-proof seal with the second handle compartment. A first stowage compartment is located on the first end of the handle. A first weight affixes to the first stowage compartment and creates a seal to close the first stowage compartment. A second weight affixes to the second stowage compartment and creates a seal to close the second stowage compartment. The first stowage compartment, the first weight, the second stowage compartment, and the second weight circumscribe a center axis by a second maximum radial distance. The second maximum radial distance is greater than the first maximum radial distance, giving the device a profile of a dumbbell.

A plurality of weights included in the multi-function hand weight to increase the heaviness at the users' discretion. Additional weights stacked onto the first weight and second weights. The third weight is affixable to the first weight and the fourth weight is affixable to the second weight. A fifth weight is affixable to the third weight, such that the third weight is located between the fifth weight and the handle along the center axis. A sixth weight is affixable to the fourth weight such that the fourth weight is located between the sixth weight and the handle along the center axis. Each of the six weights includes a plurality of light emitting diode (LED) lights distributed about the center axis. LED lights on the weights are powered by a rechargeable energy source and controlled by a user interface that allows a user to toggle the lights on and off as well as control the flashing modes and brightness. The apparatus allows for further functionality through a plurality of clips configured to removably couple other items including carabiners and D-rings to the multi-function hand weight.

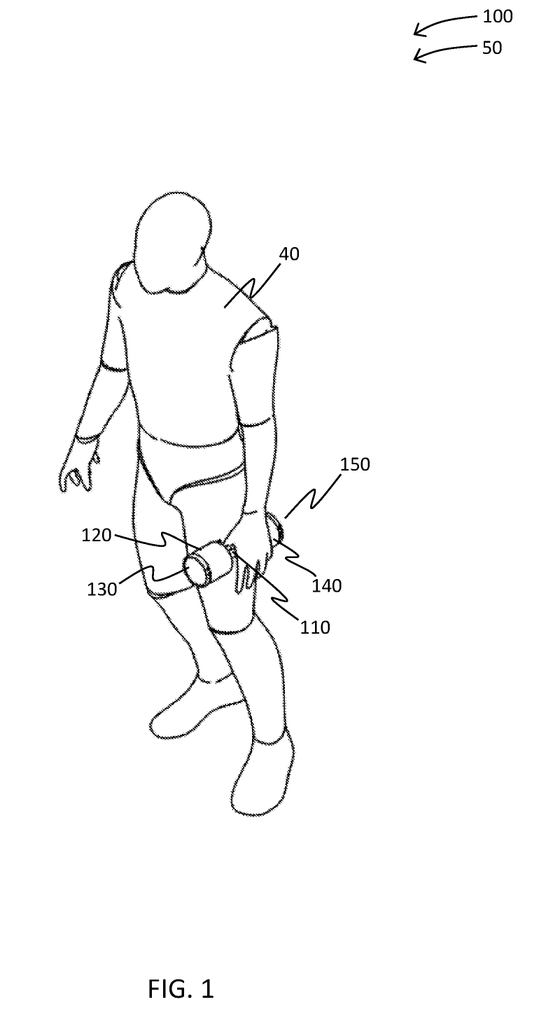

Referring now more specifically to the drawings by numerals of reference, there is shown in FIGS. 1-4B, various views of a multi-function hand weight 100.

FIG. 1 is perspective view of a multi-function hand weight during an ‘in-use’ condition 50, according to an embodiment of the present disclosure. Here, the multi-function hand weight may be beneficial for use by a user 40 to discreetly carry pet supplies. As illustrated, the multi-function hand weight 100 may include a first stowage compartment 120 and a second stowage compartment 140 on opposite sides of a handle 110 for a user 40 to grip. A first weight 130 is attached to the first stowage compartment 120. A second weight 150 is attached to the second stowage compartment 140. The first weight 130 and the second weight 150 may be configured to provide a means of sealing shut the first stowage compartment 120 and the second stowage compartment 140.

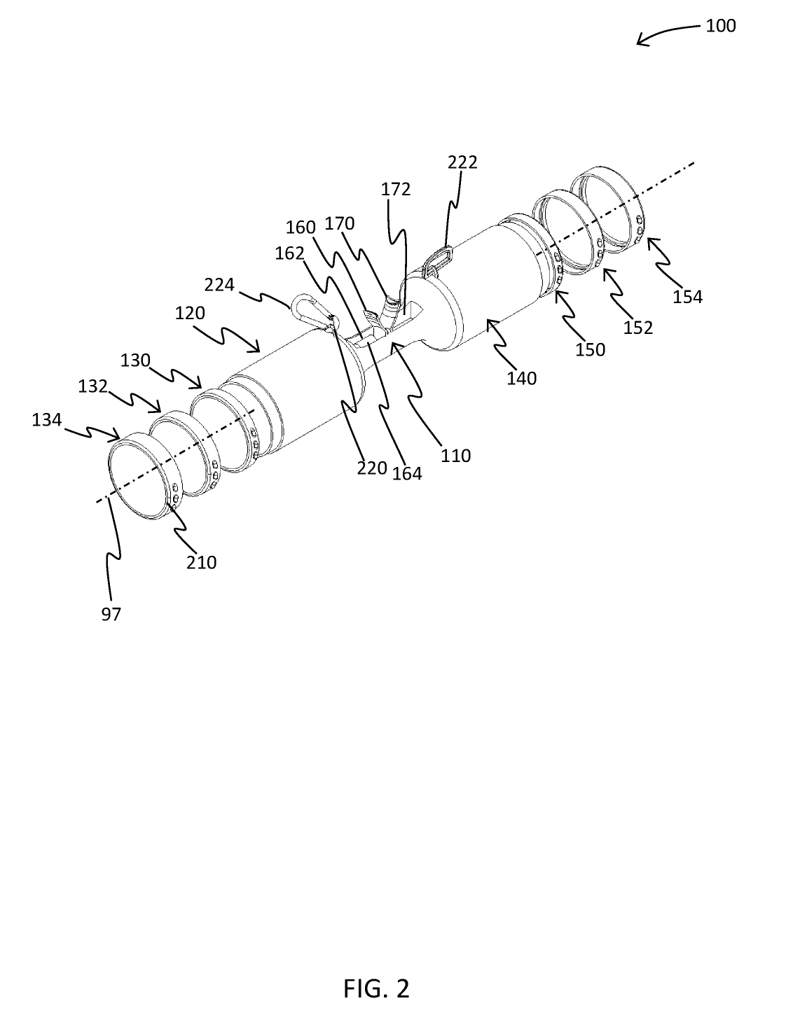

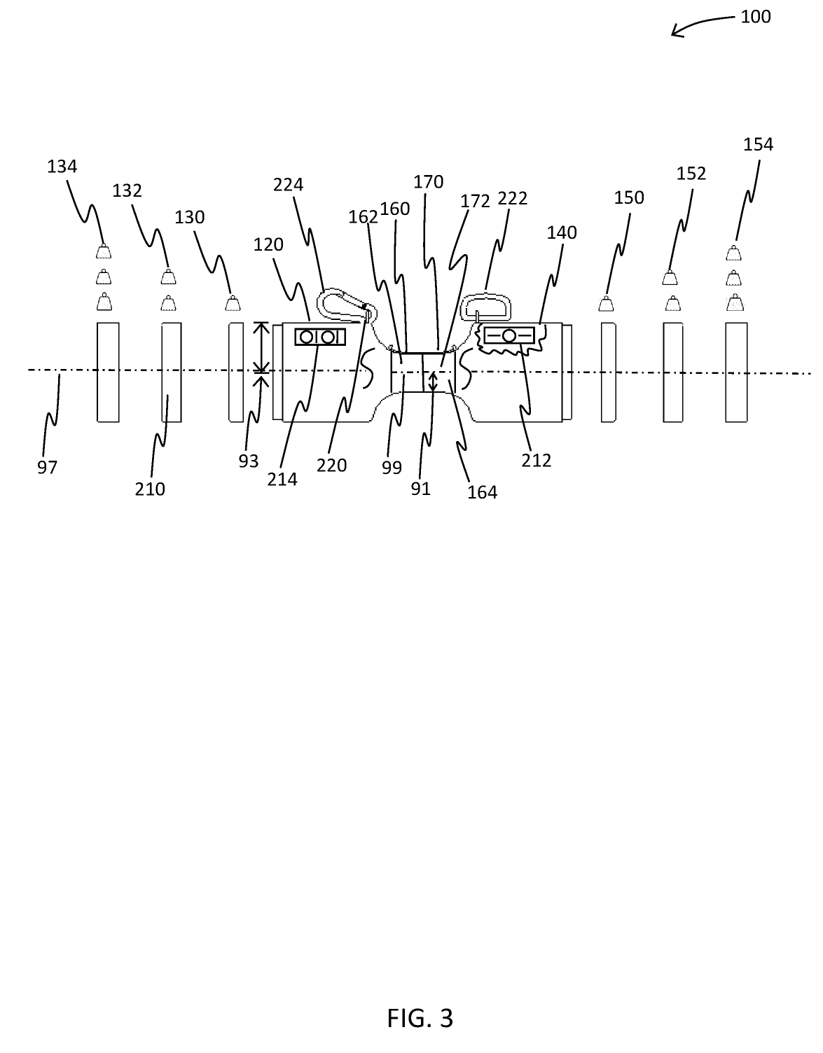

FIG. 2 is an exploded perspective view of the multi-function hand weight of FIG. 1, according to an embodiment of the present disclosure. FIG. 3 is an exploded partially cutaway side view of the multi-function hand weight of FIG. 1, according to an embodiment of the present disclosure. As above, the multi-function hand weight 100 may include the handle 110, the first stowage compartment 120, the first weight 130, the second stowage compartment 140, and the second weight 150.

The handle 110 circumscribes a grip axis 99 by a first maximum radial distance 91. The handle 110 may host a first handle compartment 162 and a second handle compartment 172. The first handle compartment 162 may contain a spindle 164 configured to hold waste bags. A first access panel 160 is pivotably attached adjacent to the first handle compartment 162. The first access panel 160 pivots between a latched state and an unlatched state, where the latched state creates a seal with the first access panel 160. A second access panel 170 is pivotably attached adjacent to the second handle compartment 172. The second access panel 170 pivots between a latched state and an unlatched state, where the latched state creates a seal with the second access panel 170.

As shown, the multi-function hand weight 100 includes a first stowage compartment 120 and a second stowage compartment 140 circumscribing a center axis 97 by a second maximum radial distance 93. A first weight 130 is attached to the first stowage compartment 120 to create a fluid-proof seal. A third weight 132 is attachable to the first weight 130. A fifth weight 134 is attachable to the third weight 132. Similarly, a second weight 150 is attached to the second stowage compartment 140 to create a fluid-proof seal. A fourth weight 152 is attachable to the second weight 150. A sixth weight 154 is attachable to the fourth weight 152. Wherein each of the six independent weights includes a plurality of LED lights 210. The LED lights 210 are powered by an energy source 212. The LED lights 210 are controlled by a user interface 214 which may be used to toggle the power state of the LED lights 210 as well as modes of brightness and flashing.

A utility clip 220 is located at the second maximum radial distance 93 proximate to the handle 110 on each the first stowage compartment 120 and the second stowage compartment 140. The utility clip 220 is configured to hold a carabiner 224 and alternatively a D-ring 222.

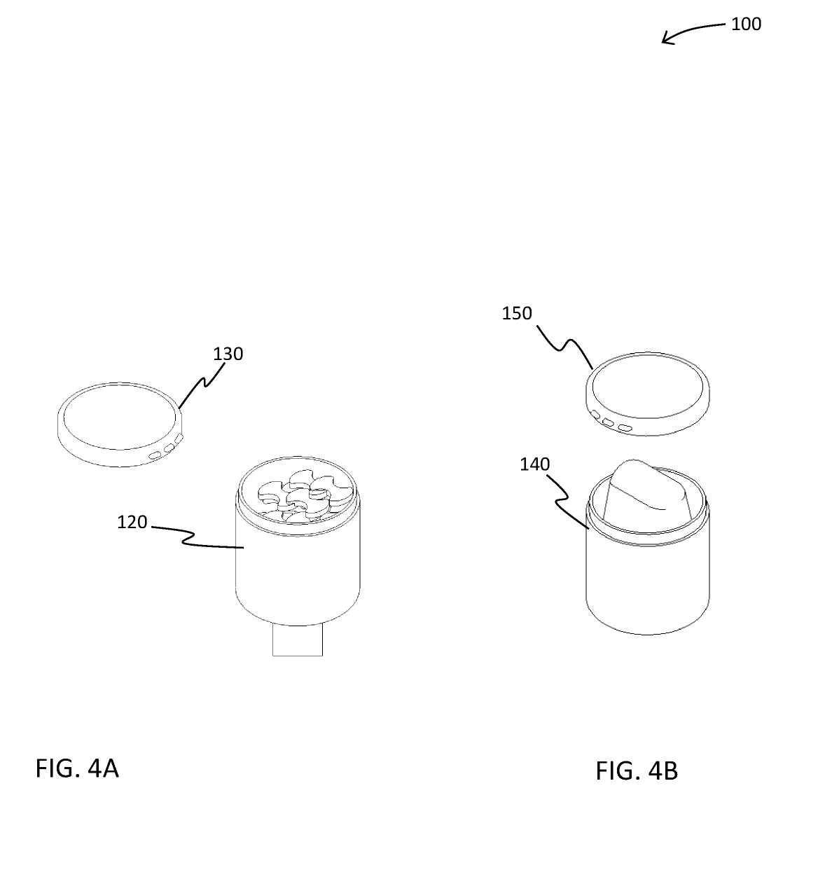

FIG. 4A is a detail view of portions of the multi-function hand weight of FIG. 1, according to an embodiment of the present disclosure. FIG. 4B is a detailed view of portions of the multi-function hand weight of FIG. 1, according to an embodiment of the present disclosure. Illustrated in FIG. 4A is the first stowage compartment 120 with its corresponding first weight 130 removed to provide access to the cavity within the first stowage compartment 120. FIG. 4A illustrates the first stowage compartment 120 holding items. The first weight 130 is affixed to the first stowage compartment 120 to retain the items within the first stowage compartment 120. FIG. 4B illustrates the second stowage compartment 140 with its corresponding second weight 150 removed to provide access to the cavity within the second stowage compartment 140. FIG. 4B illustrates the second stowage compartment 140 holding other items. The second weight 150 is affixed to the second stowage compartment 140 to retain the items within the second stowage compartment 120.

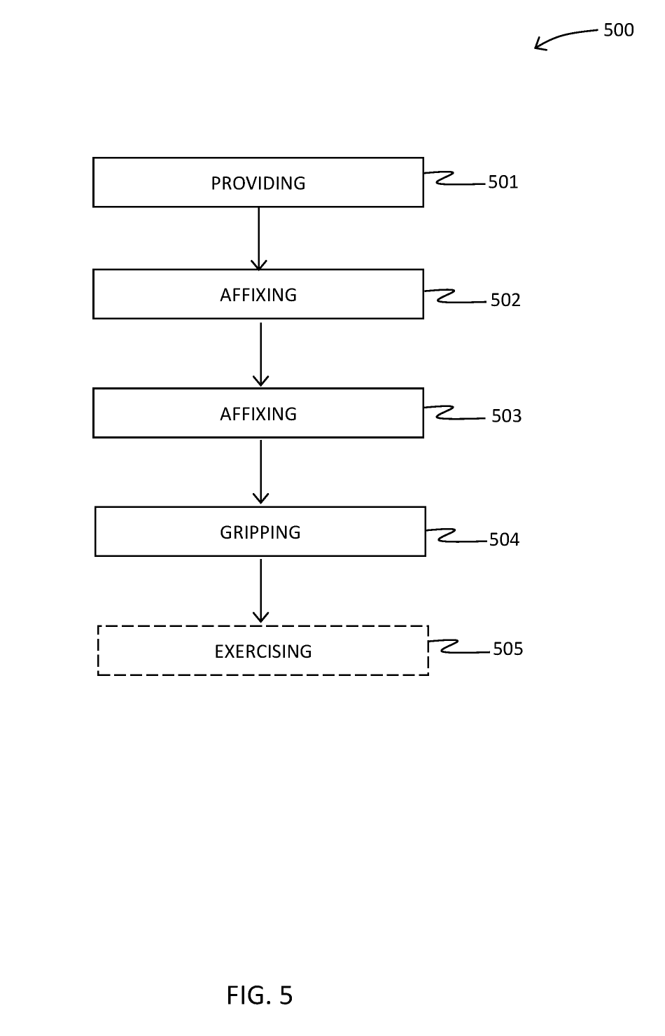

FIG. 5 is a flow diagram illustrating a method of use of a multi-function hand weight, according to an embodiment of the present disclosure. In particular, the method for using a multi-function hand weight multi-function hand weight 500 may include one or more components or features of the multi-function hand weight 100 as described above. As illustrated, the method for using a multi-function hand weight 500 may include the steps of: step one 501, providing multi-function hand weight for containing pet supplies, the multi-function hand weight including a handle having a grip axis, a first end, and a second end opposite the first end along the grip axis, the handle including a first handle compartment inside the handle and proximate the first end, and a second handle compartment inside the handle and proximate the second end, a first stowage compartment affixed to the first end of the handle, and a second stowage compartment affixed to the second end of the handle, step two 502, affixing a first weight to the first stowage compartment, on an end opposite from the first end of the handle relative to the center axis; step three 503, affixing a second weight to the second stowage compartment, on an end opposite from the second end of the handle relative to the center axis, 504, gripping the handle; step five 505, exercising with hand weight.

It should be noted that step 505 is an optional step and may not be implemented in all cases. Optional steps of the method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using a multi-function hand-weight, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A multi-function hand weight for containing pet supplies, the multi-function hand weight comprising:
a handle having a grip axis, a first end, and a second end opposite the first end along the grip axis, the handle including a first handle compartment inside the handle and proximate the first end, and a second handle compartment inside the handle and proximate the second end;
a first stowage compartment affixed to the first end of the handle;
a first weight affixed to the first stowage compartment;
a second stowage compartment affixed to the second end of the handle; and
a second weight affixed to the second stowage compartment.

2. The multi-function hand weight of claim 1, wherein the handle circumscribes the grip axis by a first maximum radial distance; and
wherein the first stowage compartment, the first weight, the second stowage compartment, and the second weight circumscribe a center axis by a second maximum radial distance, said center axis being parallel with the grip axis, and said second maximum radial distance being greater than the first maximum radial distance.

3. The multi-function hand weight of claim 2, wherein the handle further includes a first access panel configured to provide access to the first handle compartment, and a second access panel configured to provide access to the second handle compartment, said first access panel configured to move between a latched state and alternatively an unlatched state, and said second access panel configured to move between a latched state and alternatively an unlatched state

4. The multi-function hand weight of claim 3, wherein said first handle compartment further includes a spindle configured to hold pet waste bags and provide for said pet waste bags to be dispensed upon pulling by a user.

5. The multi-function hand weight of claim 3, wherein said second handle compartment and said second access panel form a fluid proof seal when in the latched state create, said fluid proof seal capable of retaining moisture of enclosed contents within said second handle compartment.

6. The multi-function hand weight of claim 1, further comprising a third weight affixable to the first weight;
a fourth weight affixable to the first weight;
a fifth weight affixable to the third weight such that the third weight is located between the fifth weight and the handle along the center axis; and
a sixth weight affixable to the fourth weight such that the fourth weight is located between the sixth weight and the handle along the center axis.

7. The multi-function hand weight of claim 1, further comprising a plurality of light emitting diode (LED) lights distributed about the center axis and affixed to at least one of the first stowage compartment and the second stowage compartment, and the first weight and the second weight.

8. The multi-function hand weight of claim 7, further comprising an energy storage configured to power the LED lights.

9. The multi-function hand weight of claim 8, further comprising a charge port configured to deliver charge to the energy storage, said charge port further configured to receive an USB plug.

10. The multi-function hand weight of claim 8, further comprising a user interface configured to operate the LED lights.

11. The multi-function hand weight of claim 10, wherein the LED lights are controllable to flash and modify brightness via the user interface.

12. The multi-function hand weight of claim 1, wherein the center axis is coaxial with the grip axis;
wherein the first stowage compartment is interspersed between the first end of the handle and the first weight along the center axis, and the second stowage compartment is interspersed between the second end of the handle and the second weight along the center axis; and
wherein the first weight is configured as a securable first cover to the first stowage compartment, and the second weight is configured as a securable second cover to the second stowage compartment.

13. The multi-function hand weight of claim 11, wherein the first weight and the second weight are securable to the first stowage compartment and the second stowage compartment, respectively, via a threaded coupling.

14. The multi-function hand weight of claim 1, wherein the first weight and the second weight are further configured to form a fluid proof seal when secured to the first stowage compartment and the second stowage compartment, respectively.

15. The multi-function hand weight of claim 1, further comprising a clip affixed to the multi-function hand weight and configured to removably couple other items to the multi-function hand weight.

16. The multi-function hand weight of claim 15, wherein said clip includes a D-ring.

17. The multi-function hand weight of claim 15, wherein said clip includes a carabiner.

18. A multi-function hand weight for containing pet supplies, said multi-function hand weight comprising:
a handle having a grip axis, a first end, and a second end opposite the first end along the grip axis, the handle including a first handle compartment inside the handle and proximate the first end, and a second handle compartment inside the handle and proximate the second end;
a first stowage compartment affixed to the first end of the handle;
a first weight affixed to the first stowage compartment;
a second stowage compartment affixed to the second end of the handle;
a second weight affixed to the second stowage compartment;
a third weight affixable to the first weight;
a fourth weight affixable to the second weight;
a fifth weight affixable to the third weight such that the third weight is located between the fifth weight and the handle along the center axis;
a sixth weight affixable to the fourth weight such that the fourth weight is located between the sixth weight and the handle along the center axis a plurality of light emitting diode (LED) lights distributed about the center axis and affixed to at least one of the first stowage compartment and the second stowage compartment, and the first weight and the second weight;
an energy storage configured to power the LED lights;
a charge port configured to deliver charge to the energy storage, said charge port further configured to receive an USB plug
a user interface configured to operate the LED lights; and
a clip affixed to the multi-function hand weight and configured to removably couple other items to the multi-function hand weight; and
wherein the handle circumscribes the grip axis by a first maximum radial distance;
wherein the first stowage compartment, the first weight, the second stowage compartment, and the second weight circumscribe a center axis by a second maximum radial distance, said center axis being parallel with the grip axis, and said second maximum radial distance being greater than the first maximum radial distance;
wherein the handle further includes a first access panel configured to provide access to the first handle compartment, and a second access panel configured to provide access to the second handle compartment, said first access panel configured to move between a latched state and alternatively an unlatched state, and said second access panel configured to move between a latched state and alternatively an unlatched state;
wherein said first handle compartment further includes a spindle configured to hold pet waste bags and provide for said pet waste bags to be dispensed upon pulling by a user;
wherein said second handle compartment and said second access panel form a fluid proof seal when in the latched state create, said fluid proof seal capable of retaining moisture of enclosed contents within said second handle compartment;
wherein the LED lights are controllable to flash and modify brightness via the user interface;
wherein the center axis is coaxial with the grip axis;
wherein the first stowage compartment is interspersed between the first end of the handle and the first weight along the center axis, and the second stowage compartment is interspersed between the second end of the handle and the second weight along the center axis;
wherein the first weight is configured as a securable first cover to the first stowage compartment, and the second weight is configured as a securable second cover to the second stowage compartment;
wherein the first weight and the second weight are securable to the first stowage compartment and the second stowage compartment, respectively, via a threaded coupling;
wherein the first weight and the second weight are further configured to form a fluid proof seal when secured to the first stowage compartment and the second stowage compartment, respectively; and
wherein said clip includes a carabiner.

19. A method of using a multi-function hand weight, the method comprising the steps of:
providing multi-function hand weight for containing pet supplies, the multi-function hand weight including
a handle having a grip axis, a first end, and a second end opposite the first end along the grip axis, the handle including a first handle compartment inside the handle and proximate the first end, and a second handle compartment inside the handle and proximate the second end,
a first stowage compartment affixed to the first end of the handle, and
a second stowage compartment affixed to the second end of the handle;
affixing a first weight to the first stowage compartment, on an end opposite from the first end of the handle relative to the center axis;
affixing a second weight to the second stowage compartment, on an end opposite from the second end of the handle relative to the center axis;
gripping the handle; and
exercising.
